(19) United States
(12) Patent Application Publication
(10) Pub. No.: US 2010/0200675 A1
(43) Pub. Date: Aug. 12, 2010

(54) Foam Spray Gun

(76) Inventor: XUFENG TU, Yuyao (CN)

Correspondence Address: GLOBAL IP SERVICES, 7285 W. Eagle Court, Winton, CA, 95388, US

(21) Appl. No.: 12/464,848

(22) Filed: May 12, 2009

(30) Foreign Application Priority Data
Feb. 11, 2009 (CN) 200910096110.1

(51) Int. Cl. B05B 15/02

(52) U.S. Cl. 239/428.5

(57) ABSTRACT

A kind of foam spray gun, comprising a gun body, a nozzle, a trigger, a one-way liquid inlet mechanism, a piston rod, a piston, a resetting piece, a one-way valve and 2 foaming screen meshes, said gun body being provided with a foam generating channel, said piston sleeve being mounted on the inner side of said trigger and moving inward under the driving force of said trigger and engaged with said gun body, said piston being mounted on inner cavity of said piston sleeve and moving together with said piston sleeve and engaged with said gun body to form the first cavity and the second cavity, said one-way valve and foaming screen meshes being mounted inside the foam generating channel of said gun body. Compared with existing technologies, this patent is advantageous in that: it organically combines the foam generating mechanism formed by the one-way valve and one-way valve sidepiece with first cavity and second cavity of the gun body, allowing the liquid to be gathered at the liquid outlet of the one-way valve to form foams and then enter the screen mesh for secondary foaming, which ensures rich foams as well as reasonable and practical structure, moreover, it adopts the trigger type, which is simple and continent, labor saving and provided with fine handle for repeatedly operation.

### CROSS REFERENCE TO RELATED PATENT APPLICATION

The present application claims the priority of the Chinese patent application No. 200910096110.1 filed on Feb. 11, 2009, which application is incorporated herein by reference.

### FIELD OF THE INVENTION

This invention relates to a kind of liquid spray gun, and more specifically, a kind of spray gun that generates form for washing vehicles and glass, etc.

### BACKGROUND OF THE INVENTION

At present, spray devices for detergents, cleansing solutions and cosmetics mainly adopts the method of mist spraying, however, it is hard for this traditional method of spraying to control the volume for local spraying, waste is often caused, while foam spraying will be more reasonable in this case, moreover, foam spraying provides users with a new style of spraying and the market with a new attraction.

Existing foam spray devices mainly adopt a form nozzle installed on the spray gun to realize spraying, e.g., Chinese patent No. ZL95117596.3 Foaming Nozzle Assembly for Triggering Sprayer (Authorization Notice No.: CN2632010C), which comprises an inner cylinder and foam enhancing device with smooth inside wall, which forms a swirl cavity coaxial with the outlet, a cone-shaped spray flow is released from the outlet along the downstream direction and enters said swirl cavity so that foam can be generated when spray particles impacts said smooth inside wall and be mixed with the air in said swirl cavity to form foam bubbles; the foam enhancing device comprises several ribs with flat surface vertical to the inside wall of the swirl cavity so that foam can be further produced when foam bubbles impact said plate surface so as to be further mixed with the air in said swirl cavity. Chinese patent application No. 96105369.0 Double Foaming Nozzle Assembly for Triggering Sprayer (Publication No.: CN1167016A) is another similar device, both products mentioned above need to be cooperated with special spray guns to realize spraying, which limits their applications.

There are also pressing-type foam spraying devices, such as Chinese utility model patent No. ZL03209871.5 Mechanical Foam Nozzle (Authorization Notice No.: CN2632010Y), comprising a nozzle, a nozzle located at the center of the nozzle base and a one-way outlet mechanism, said nozzle being provided with a liquid outlet hole, said one-way outlet mechanism being provided with a liquid inlet and a liquid outlet, said one-way outlet mechanism being linked with the nozzle and the liquid outlet being connected with the liquid outlet hole of the nozzle, featured by that said one-way outlet mechanism is provided with a screen mesh at the liquid outlet. Chinese utility model patent No. ZL200620060605.0 Foam-producing Nozzle (Publication No.: CN200970562Y) is another similar device. However, pressing repeatedly within a short period of time is laborious, which may impact the effect of usage, and the quantity of foam generated is limited.

### SUMMARY OF THE INVENTION

This invention is to provide a trigger-type foam spray gun with simple operation and rich foam in order to solve the problems mentioned above.

Technical solution of this patent to solve said problems is:

A kind of foam spray gun, comprising:
a gun body, with the foam generating channel;
a nozzle, located at the head of the gun body;
a trigger, mounted on said gun body;
a one-way liquid inlet mechanism, located at the liquid inlet of said gun body;
said spray gun further comprising:
a piston sleeve, mounted on the inner side of said trigger and moving inward under the driving force of said trigger and engaged with said gun body;
a piston, mounted on inner cavity of said piston sleeve and moving together with said piston sleeve and engaged with said gun body to form the first cavity and the second cavity, said first cavity and second cavity being connected with said foam generating channel of said gun body through air channel 1 and air channel 2 respectively;
a resetting piece, which always forcing said piston sleeve moving towards the outside;
an one-way valve, located inside the foam generating channel of said gun body, the liquid outlet of said one-way valve being tightly sealed or connected with said air channel 1 though a one-way valve sidepiece, the liquid inlet of said one-way valve being connected with said air channel 2;
at least a foaming screen mesh, located inside the foam generating channel of said gun body and between the liquid outlets of said one-way valve and said nozzle.

As an optimal choice, the foam generating channel of said gun body comprises the horizontal channel and vertical channel, the direction of the movement of said piston is generally parallel to said horizontal channel and generally vertical to said vertical channel, said one-way valve is located in said vertical channel.

To improve the effect of foam generation, 2 said foaming screen meshes are provided, one near said nozzle, the other near said one-way valve and inside said vertical channel.

To improve the effect of foam generation and the reasonable transition of liquid, said vertical channel is further provided with a lining piece with a center channel, the liquid inlet of said lining piece is connected with said one-way liquid inlet mechanism, and the liquid outlet of said lining piece is connected with the liquid inlet of said one-way valve. Said lining piece is further provided with a transverse opening at the liquid outlet, said transverse opening is connected with said air channel 2. This not only facilitates the connection with air channel 2, but also greatly reduces the volume of the vertical channel and improves the foaming effect.

To facilitate production and assembly, said one-way valve sidepiece forms integrally on the side wall of said one-way valve, the head of which being an inverse U in general, with the nozzle mounted on top of the head.

To maintain balance between the intensity of pressure inside the liquid container and the atmosphere outside in normal state, an air-return mechanism is required, best embodiment of the air-return mechanism is designed as follows: said gun body is provide with an air-return channel for connection with said one-way liquid inlet mechanism, said piston sleeve with a small piston part on the bottom, which forms an air-return mechanism with said piston air-retune channel through the air-return cavity of said gun body.

Best embodiment of said one-way liquid inlet mechanism is designed as follows: said one-way liquid inlet mechanism comprises:

A lid, located at the liquid inlet end of said gun body with a V-shape liquid outlet on the top and a liquid inlet pipe on the bottom;

A ball, located at the V-shape liquid outlet on said lid to close said V-shape liquid outlet when no liquid is passing;

And a large cover, connected with said lid on the top and being capable of engaged with outlet of the liquid container.

To facilitate layout of the inside space and reduce the volume of installation, said first cavity and second cavity are generally coaxial, correspondingly, said piston comprises the inner piston part and the outer piston part.

Compared with existing technologies, this patent is advantageous in that: it organically combines the foam generating mechanism formed by the one-way valve and one-way valve sidepiece with first cavity and second cavity of the gun body, allowing the liquid to be gathered at the liquid outlet of the one-way valve to form foams and then enter the screen mesh for secondary foaming, which ensures rich foams as well as reasonable and practical structure, moreover, it adopts the trigger type, which is simple and continent, labor saving and provided with fine handle for repeatedly operation.

### DESCRIPTION OF THE DRAWINGS

FIG. 1 is the structural representation of the embodiment.

FIG. 2 is the exploded assembly drawing of the embodiment.

FIG. 3 is the cutaway view of the embodiment (with liquid inlet pipe installed).

FIG. 4 is the zoom-in view of the one-way valve in FIG. 2.

FIG. 5 is the zoom-in view of the lining piece in FIG. 2;

FIG. 6 is the schematic diagram of air return in first cavity;

FIG. 7 is the schematic diagram of the sealing of first cavity;

### DETAILED DESCRIPTION OF THE INVENTION

Detailed description of this patent will now be described with reference to the drawings for an embodiment of this invention.

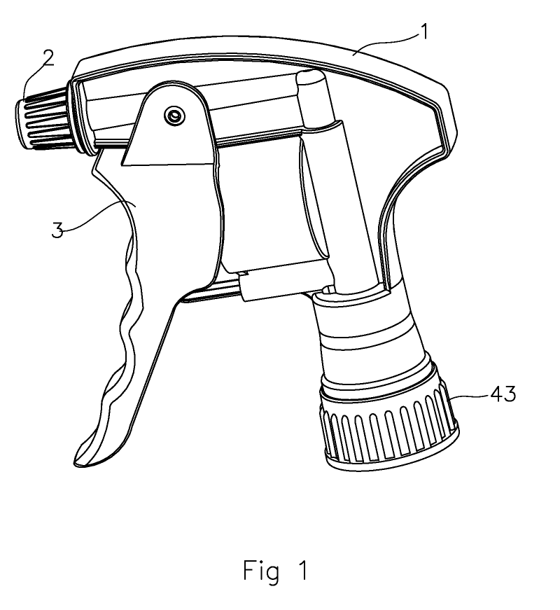

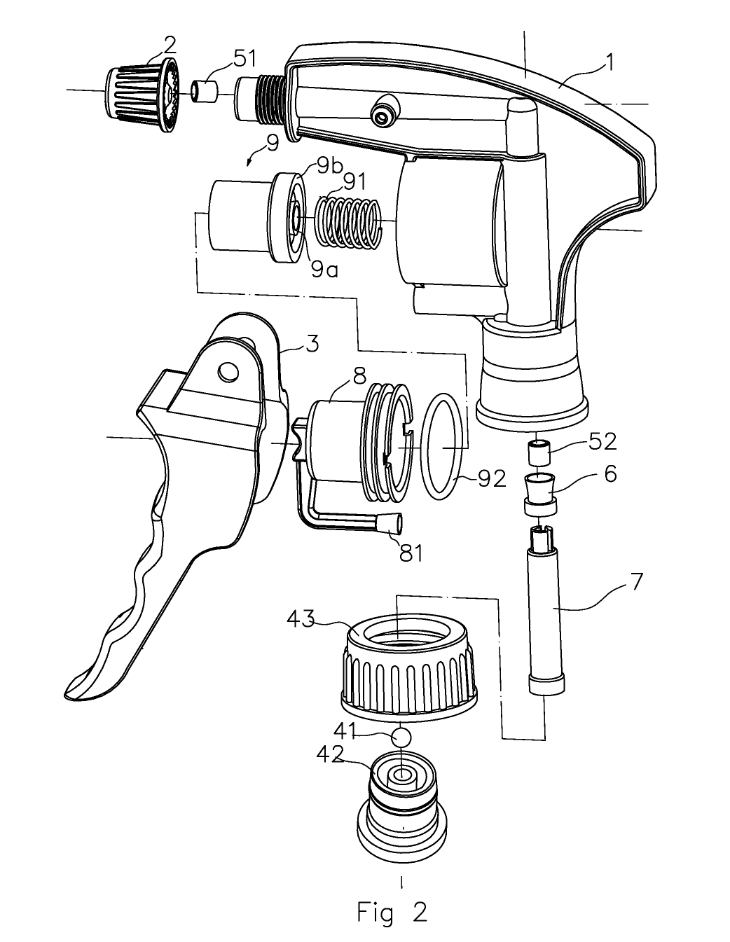

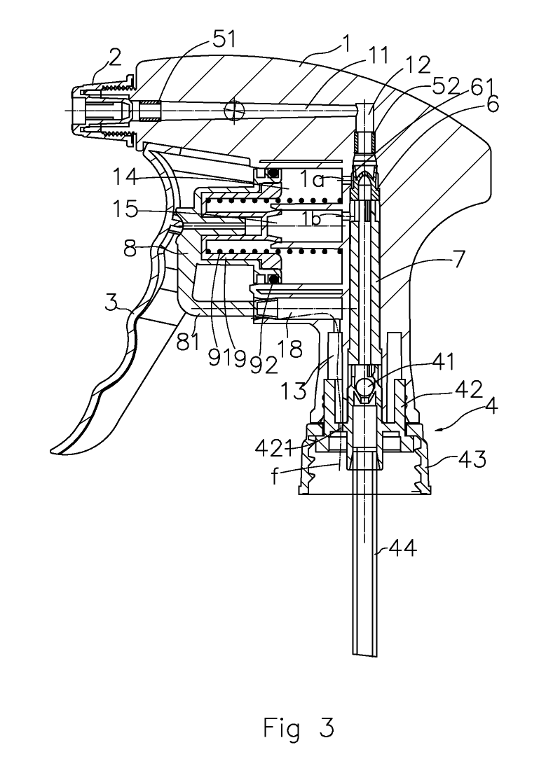

Embodiment: as shown in FIG. 1, FIG. 2 and FIG. 3, in this embodiment, the foam spray gun comprises the gun body 1, the nozzle 2, the trigger 3, the one-way liquid inlet mechanism 4, the piston sleeve 8, the piston 9, the resetting piece 91, the one-way valve 6, 1^{st} screen mesh 51, 2^{nd} screen mesh 52 and the lining piece 7.

The gun body 1 comprises the foam generating channel, which comprises the horizontal channel 11 and the vertical channel 12. The nozzle 2 is located at the head of the gun body land connected with the spraying end of the horizontal channel 11, the trigger 3 is located on the gun body 1.

The one-way liquid inlet mechanism 4 comprises the lid 42, ball 41 and large cover 43, the lid 42 is located at the liquid inlet end of the gun body 1, with a V-shape liquid outlet on the top and a liquid inlet pipe 44 on the bottom, the ball 41 is located at the V-shape liquid outlet of lid 42 to close the V-shape liquid outlet when no liquid is passing, the large cover 43 is connected with the lid body on the top and engaged with the screw at the outlet of the liquid container for general sealing.

The piston sleeve 8 is mounted on the inner side of the trigger 3 and moving inward under the driving force of the trigger 3 and engaged with the gun body 1, the direction of the movement of the piston 8 is generally parallel to the horizontal channel 11 and generally vertical to said vertical channel 12.

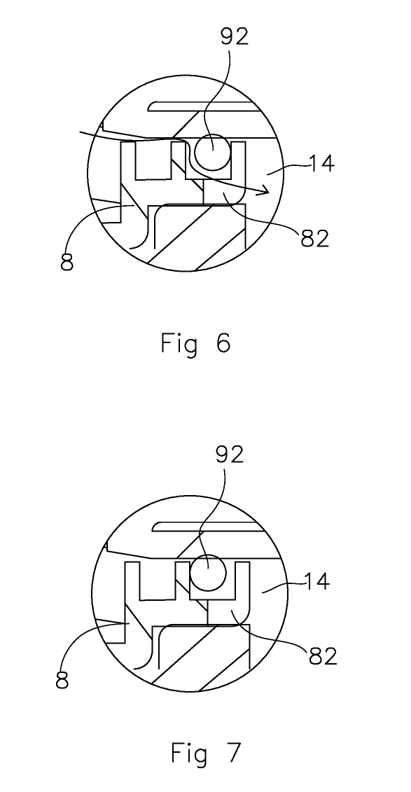

The piston 9 is mounted on inner cavity of said piston sleeve 8 and moving together with the piston sleeve 8 and engaged with said gun body 1 to form the first cavity 14 and the second cavity 15, a ring groove is made along the outer circumference of the piston sleeve 8, with O-ring 92 inside, an opening 82 is made between the inner wall and the bottom of the ring groove, allowing air return and tight engagement between the piston sleeve 8 and the first cavity 14, please see FIGS. 6 and 7 for details, when the piston sleeve 8 moves towards the outside, the O-ring 92 blocks the inner wall of the ring groove to make the air outside to enter the first cavity 14 through the opening 82 so as to compensate air, when the piston sleeve 8 moves towards the inside, the O-ring 92 blocks the outer wall of the ring groove to realize sliding sealing between the piston sleeve 8 and the first cavity 14 so as to prevent air outside from entering the first cavity 14 though the opening 82, first cavity 14 and second cavity 15 are connected to vertical channel 12 inside the gun body 1 respectively through air channel 1 1a and air channel 2 1b, air channel 1 1a being located above air channel 2 1b, and first cavity 14 and second cavity 15 being generally coaxial, correspondingly, the piston 9 comprises the inner piston part 9a and the outer piston part 9b.

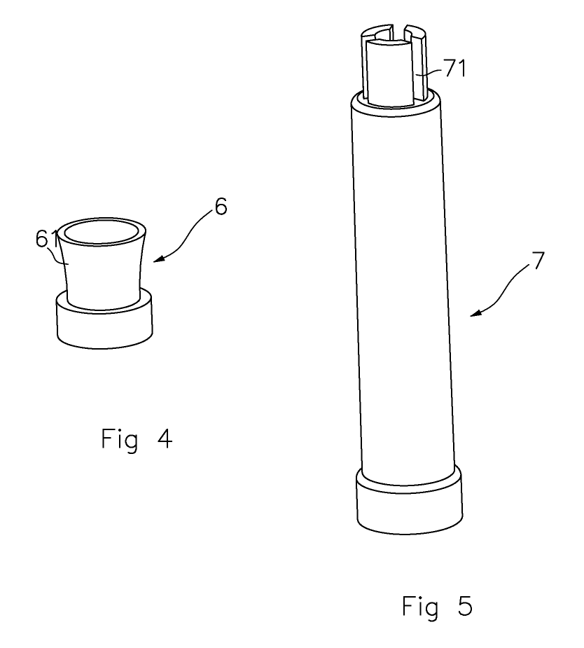

The resetting piece 91 is a return spring that always forcing the piston sleeve 8 moving towards the outside, one end of the resetting piece 91 contacts the inner wall of the piston 9 and is located between the inner piston part 9a and the outside piston part 9b, the other end touches the inner wall of the gun body 1. The one-way valve 6 is located inside the vertical channel 12, the liquid outlet of the one-way valve 6 is connected with the air channel 1 1a for sealing and engagement through a cone-shaped one-way valve sidepiece 61, the liquid outlet of the one-way valve 6 is connected with the air channel 2 1b, please see FIGS. 2 and 4 for details, the one-way valve sidepiece 61 forms integrally on the side wall of the one-way valve 6, the head of which being an inverse U in general, with the nozzle mounted on top of the head.

The 1^{st} foaming screen mesh 51 and the 2^{nd} foaming screen mesh 52 are respectively located inside the horizontal channel 11 and the vertical channel 12 and between the liquid outlet of the one-way valve and the nozzle, the 1^{st} foaming screen mesh 51 being located near the nozzle 2, the 2^{nd} foaming screen mesh 52 being located near the one-way valve 6.

The lining piece 7 is located inside the vertical channel 12 and provided with a center channel, with the liquid inlet connected with the one-way liquid inlet mechanism 4 and the liquid outlet connected with the liquid inlet of the one-way valve 6. As shown in FIG. 5, the lining piece 7 is further provided with a transverse opening 71 at the liquid outlet, the transverse opening 71 is connected with said air channel 21b.

To maintain balance between the intensity of pressure inside the liquid container and the atmosphere outside in normal state, an air-return mechanism is required, the gun body 1 is provide with an air-return channel 13 connected with the air-return channel 421 of the lid, said piston sleeve is provided with a small expanded piston part 81 on the bottom, which forms an air-return mechanism with the air-retune channel 13 through the air-return cavity 18 of the gun body. The direction of the return air is indicated in FIG. 3 by line f, the air enters the container when the small piston part 81 moves inward.

Working principle: pull the trigger 3, which then drive the piston sleeve 8 and the piston 9 to overcome the elastic force of the resetting piece 91 to move inward horizontally, the air inside the first cavity 14 then opens the one-way valve sidepiece 61 through the air channel 11a to form a air flow, in the meanwhile, the air inside the second cavity 15 passes the air channel 21b and the transverse opening 71 of the lining piece 7 in order to drive the liquid inside the lining piece 7 to flow towards the one-way valve 6, after passing the one-way valve 6, the liquid will be mixed with the airflow from the one-way valve sidepiece 61 to produce the primary foams, and then the airflow passes the 2^{nd} foaming screen mesh 52 and the 1^{st} foaming screen mesh 51 in order to produce multi-level foams, which are finally sprayed out through the nozzle 2; after releasing the trigger 3, the piston sleeve 8 and the piston 9 are reset, the one-way valve sidepiece 61 is closed, and the liquid is compensated from the container into the lining piece 7 for standby. And then repeat the steps above.

What is claimed is:

1. A kind of foam spray gun, comprising:
a gun body having a foam generating channel;
a nozzle located at a head of the gun body;
a trigger mounted on said gun body;
an one-way liquid inlet mechanism located at a liquid inlet of said gun body;
wherein said spray gun further comprising:
a piston sleeve mounted on the inner side of said trigger and moving inward under the driving force of said trigger and engaged with said gun body;
a piston mounted in inner cavity of said piston sleeve and moving together with said piston sleeve and engaged with said gun body to form a first cavity and a second cavity, said first cavity and second cavity are connected with said foam generating channel of said gun body through an air channel 1 and an air channel 2 respectively;
a resetting piece, which always forces said piston sleeve moving towards the outside;
an one-way valve located inside the foam generating channel of said gun body, a liquid outlet of said one-way valve is sealed or connected with said air channel 1 though a one-way valve sidepiece, a liquid inlet of said one-way valve is connected with said air channel 2;
at least a foaming screen mesh located inside the foam generating channel of said gun body and between the liquid outlets of said one-way valve and said nozzle.

2. The foam spray gun according to claim 1, wherein the foam generating channel of said gun body comprises a horizontal channel and a vertical channel, the direction of the movement of said piston is generally parallel to said horizontal channel and generally vertical to said vertical channel, said one-way valve is located in said vertical channel.

3. The foam spray gun according to claim 2, wherein two pieces said foaming screen mesh are provided, one is near said nozzle, the other is near said one-way valve and inside said vertical channel.

4. The foam spray gun according to claim 3, wherein said vertical channel is further provided with a lining piece with a center channel, a liquid inlet of said lining piece is connected with said one-way liquid inlet mechanism, and a liquid outlet of said lining piece is connected with the liquid inlet of said one-way valve.

5. The foam spray gun according to claim 4, wherein said lining piece is further provided with a transverse opening at its liquid outlet, said transverse opening is connected with said air channel 2.

6. The foam spray gun according to any of claims 1, wherein said one-way valve sidepiece is formed integrally on the side wall of said one-way valve, the head of said one-way valve is an inverse U in general, the nozzle is mounted on top of the head.

7. The foam spray gun according to any of claims 1, wherein said gun body is provide with an air-return channel for connecting with said one-way liquid inlet mechanism, said piston sleeve has a small piston part on the bottom, the small piston part forms an air-return mechanism with said air-retune channel through the air-return cavity of said gun body.

8. The foam spray gun according to any of claims 1, wherein said one-way liquid inlet mechanism comprises:
a lid located at the liquid inlet end of said gun body with a V-shape liquid outlet on the top;
a ball located at the V-shape liquid outlet on said lid to close said V-shape liquid outlet when no liquid is passing; and
a large cover connected with said lid on the top and being capable of engaged with outlet of the liquid container.

9. The foam spray gun according to claim 8, wherein said lid is provided with a liquid inlet pipe on the bottom.

10. The foam spray gun according to any of claims 1, wherein said first cavity and second cavity are generally coaxial, correspondingly, said piston comprises an inner piston part and a outer piston part.

11. The foam spray gun according to any of claims 1, wherein the outer circumference of said piston sleeve has a ring groove with an O-ring inside, an opening is made between the inner wall and the bottom of said ring groove to allow air return and tight engagement between the piston sleeve and the first cavity.
